(19) United States
(12) Patent Application Publication
(10) Pub. No.: US 2015/0085085 A1
(43) Pub. Date: Mar. 26, 2015

(54) DISPARITY CALCULATING METHOD AND STEREO MATCHING SYSTEM THEREOF

(71) Applicant: NOVATEK Microelectronics Corp., Hsin-Chu (TW)

(72) Inventors: Guangzhi Liu, Shanghai (CN); Lei Zhou, Shanghai (CN); Cheng-Wei Chou, New Taipei City (TW)

(73) Assignee: NOVATEK Microelectronics Corp., Hsin-Chu (TW)

(21) Appl. No.: 14/098,543

(22) Filed: Dec. 6, 2013

(30) Foreign Application Priority Data
Sep. 25, 2013 (CN) 201310443375.0

(51) Int. Cl. H04N 13/04

(52) U.S. Cl. CPC H04N 13/0425
USPC 348/51

(57) ABSTRACT

A disparity calculating method for a stereo matching system includes calculating a global energy matrix according to a first image, a second image and a previous disparity matrix of a previous frame; calculating a global disparity matrix according to the global energy matrix and a first stereo matching algorithm; calculating a local energy matrix between a first image block of the first image and a second image block of the second image according to the first image block, the second image block, a previous block disparity matrix and the global disparity matrix; and calculating a local disparity matrix between the first image block and the second image block according to the local energy matrix and a second stereo matching algorithm.

### BACKGROUND OF THE INVENTION

1. Field of the Invention

The present invention relates to a disparity calculating method and stereo matching system thereof, and more particularly, to a disparity calculating method which is stable in both time and space, and a stereo matching system thereof.

2. Description of the Prior Art

As image technologies continue to progress, available sizes and functionalities of display devices become increasingly diverse. In order to meet different consumers' requirements, manufacturers try to provide new products with better outputting performance and resolution. One of the most interesting products is a display device with three-dimensional display functionality. General three-dimensional display technologies include polarized, interlaced or anaglyph display methods. These display methods utilize special optical structures to project images with different views corresponding to depth information of a person's left and right eye. As a person's left and right eye respectively captures images with different views which are then synthesized by the human brain, the person can sense a three-dimensional image.

When two-dimensional images without this depth information are displayed by a display device having three-dimensional display functionality, the display device may not generate a multi-view image since the source images for displaying lacks the depth information. Under such a condition, the display device is required to analyze the two-dimensional images to obtain the depth information, so that a multi-view image can be displayed. In the prior art, at least two images with different views first need to be obtained by utilizing multiple image capture devices located in different locations. The depth information may then be analyzed from the images with different views. A process for analyzing two images with different views to obtain the depth information is called stereo matching. In stereo matching, matching objects (or characteristics, pixels, etc.) are searched for between the two images to obtain positional differences of matching objects in the two images. The positional differences are disparity information (also called a disparity map) of the two images, and the depth information of the matching objects may be calculated by the disparity information.

When stereo matching is performed between two images for obtaining depth information, since landscapes of the two images are not entirely the same and the two images maybe captured by two image capture devices at a distance from each other, how to accurately search matching objects between the two images in order to obtain disparity information may affect accuracy of the depth information. For example, when a matching error of an object between the two images occurs, such as object A of a left-view image is matched to object B of a right-view image rather than object A of the right-view image, the disparity information of the object may be wrong and the wrong depth information may therefore be obtained. The object will be displayed with a wrong depth, and a user may not see the object, or see a deformed version of the object.

Therefore, when stereo matching is performed between two images, how to obtain an accurate stereo matching result of each object in the two images is a highly important topic in this field.

### SUMMARY OF THE INVENTION

In order to solve the above problem, the present invention provides a disparity calculating method capable of generating a disparity map with stability in both time and space, and a stereo matching device thereof.

In an aspect, a disparity calculating method for a stereo matching system comprises calculating a global energy matrix according to a first image, a second image and a previous disparity matrix of a previous frame; calculating a global disparity matrix according to the global energy matrix and a first stereo matching algorithm; calculating a local energy matrix between a first image block of the first image and a second image block of the second image according to the first image block, the second image block, a previous block disparity matrix and the global disparity matrix; and calculating a local disparity matrix between the first image block and the second image block according to the local energy matrix and a second stereo matching algorithm.

In another aspect, a stereo matching system comprises a global disparity storing module, for storing a previous disparity matrix and a global disparity matrix of a previous frame; a previous block disparity storing module, for storing a previous block disparity matrix between a first image and a second image; a current block disparity storing module, for storing a local disparity matrix; a global disparity calculating module, coupled to the global disparity storing module for calculating a global energy matrix according to the first image, the second image and the previous disparity matrix and calculating the global disparity matrix according to the global energy matrix and a first stereo matching algorithm; and a local disparity calculating module, coupled to the global disparity storing module, the previous block disparity storing module and the current block disparity storing module for calculating a local energy matrix between a first image block of the first image and a second image block of the second image according to the first image block, the second image block, the previous local disparity matrix and the global disparity matrix and calculating the local disparity matrix between the first image block and the second image block according to the local energy matrix and a second stereo matching algorithm.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a stereo matching system according to an embodiment of the present invention.

FIG. 2 is a schematic diagram of a non-linear equation according to an embodiment of the present invention.

FIG. 3 is a flow chart of a disparity calculating method according to an embodiment of the present invention.

### DETAILED DESCRIPTION

In embodiments of the present invention, a stereo matching system generates an energy matrix, for determining disparities of a current area in a current frame, according to disparity information of a previous frame and a previous area of the current frame. The disparity map outputted by the stereo matching system is continuous in both time and space and is therefore accurate and stable. The present invention is particularly shown and described with respect to at least one exemplary embodiment accompanied by drawings. Words utilized for describing connection between two components such as couple and connect should not be taken as limiting a connection between the two components to be directly coupling or indirectly coupling.

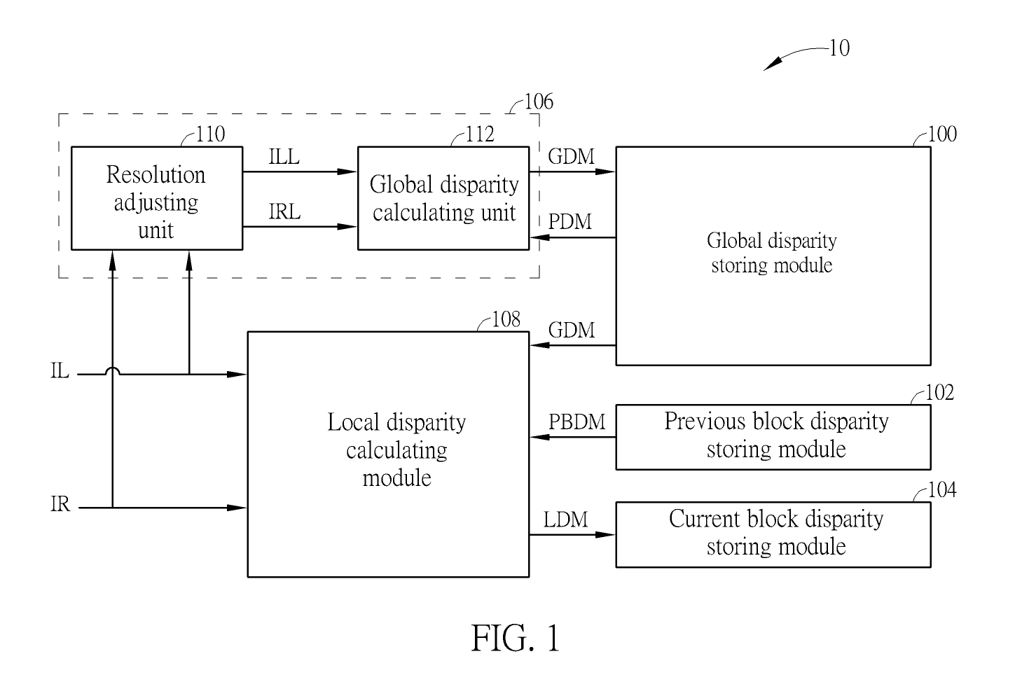

Please refer to FIG. 1, which is a schematic diagram of a stereo matching system 10 according to an embodiment of the present invention. The stereo matching system 10 is utilized for calculating disparities of pixels in a 3-dimensional (3D) image. As shown in FIG. 1, the stereo matching system 10 comprises a global disparity storing module 100, a previous block disparity storing module 102, a current block disparity storing module 104, a global disparity calculating module 106 and a local disparity calculating module 108. The global disparity storing module 100 is utilized for storing a previous disparity matrix PDM and a global disparity matrix GDM. The previous block disparity storing module 102 is utilized for storing a previous block disparity matrix PBDM between images IMG1 and IMG2. The current block disparity storing module is utilized for storing a local disparity matrix LDM. The global disparity calculating module comprises a resolution adjusting unit 110 and a global disparity calculating unit 112 and is coupled to the global disparity storing module 100. The global disparity calculating module 106 is utilized for calculating a global energy matrix GEM according to the images IMG1 and IMG2 and the previous disparity matrix PDM and calculating the global disparity matrix GDM according to the global energy matrix and a stereo matching algorithm SM1. The local disparity is coupled to the global disparity storing module 100, the previous block disparity storing module 102 and the current block disparity storing module 104 for calculating a local energy matrix LEM between an image block B1 of the image IMG1 and an image block B2, corresponding to the image block B1, of the image IMG2 according to the image blocks B1 and B2, the previous block disparity matrix PBDM and the global disparity matrix GDM. Further, the local disparity calculating module 108 calculates a local disparity matrix LDM between the image blocks B1 and B2 according to the local energy matrix LEM and a stereo matching algorithm SM2. In brief, since the global disparity matrix GDM, which is generated according to the previous disparity matrix PDM of the previous frame PF, is relative to the disparity information of the previous frame PF, the local disparity matrix LDM becomes relative to the disparity information of the previous frame PF (i.e. the local disparity matrix LDM equips the continuity in time) when the stereo matching system 10 generates the local disparity matrix according to the global disparity matrix GDM. Moreover, since the previous block disparity matrix PBDM comprises the disparity information around the image blocks B1 and B2, the local disparity matrix LDM becomes relative to the disparity information around the image blocks B1 and B2 (i.e. the local disparity matrix LDM equips the continuity in space) when the stereo matching system 10 generates the local disparity information LDM according to the previous block disparity matrix PBDM. As a result, the local disparity matrix LDM has continuities in both time and space, simultaneously, and the disparity map generated by the stereo matching system 10 can be stable and accurate.

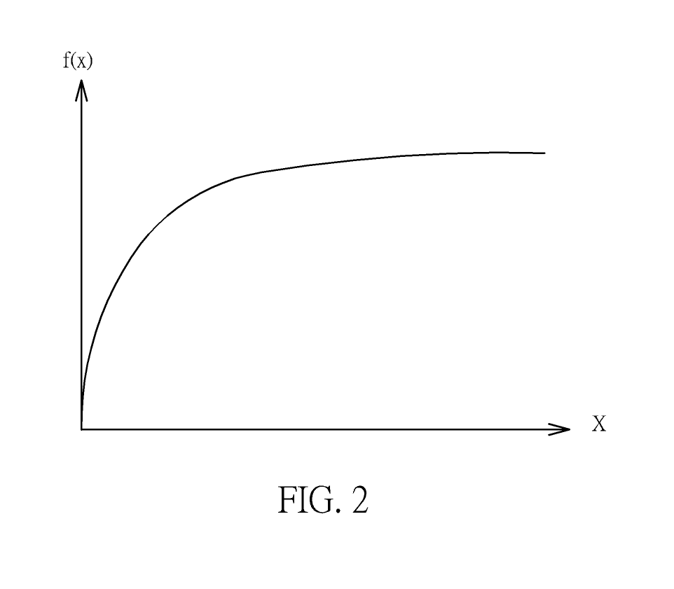

In detail, the images IMG1 and IMG2 are a left-eye image IL and a right-eye image IR of a current frame CF in a 3D image I3D in this embodiment. After receiving the left-eye image IL and the right-eye image IR, the global disparity calculating module 106 first uses the resolution adjusting unit 110 to decrease the resolutions of left-eye image IL and the right-eye image IR, respectively, for generating the left-eye image ILL and the right-eye image IRL with lower resolution. Next, the global disparity calculating unit 112 calculates the global energy matrix GEM according to the left-eye image ILL, the right-eye image IRL and the previous disparity matrix PDM corresponding to the disparity map of the previous frame PF and stored in the global disparity storing module 100. The previous frame PF may be a frame before the current frame CF and the formula of calculating the accumulative energy of a pixel x corresponding to a plurality of disparity candidates in the global energy matrix GEM can be expressed as:

$$E ( x , d ) = {min}_{k} [ E ( x - 1 , k ) + C ( x , k ) + TC ( x , k ) ] \qquad ( 1 )$$

wherein, E is the accumulative energy, C(x,k)=|Iₗ(x)−Iᵣ(x+k)|, TC(x,k)=f₁(|k−dtₙ₋₁(x)|), k is a disparity candidate within a certain searching range, Iₗ is a pixel value corresponding to the pixel x in the left-eye image ILL, Iᵣ is a pixel value corresponding to the pixel x in the right-eye image IRL, dtₙ₋₁(x) is the disparity corresponding to the pixel x in the previous disparity matrix PDM and f₁( ) is a non-linear mapping equation. f₁( ) may be a non-linear mapping equation shown in FIG. 2, but is not limited herein.

According to the equation (1), the global disparity calculating module 105 can acquire the global energy matrix GEM and calculate the global disparity matrix GDM via the stereo matching algorithm SM1. Note that, when the difference between the disparity candidate k and the disparity dtₙ₋₁(x) corresponding to the same pixel x in the previous frame PF is greater, the value of TC(x,k) becomes larger (i.e. the value of TC(x,k) is proportional to the difference between the disparity candidate k and the disparity dtₙ₋₁(x)). Since TC(x,k) is added to the equation (1), the global disparity matrix GEM becomes relative to the disparity information of the previous frame PF. In other words, the global disparity matrix GEM equips the continuity in time after adding TC(x,k).

The local disparity calculating module 108 calculates the local energy matrix LEM between the image block B1 of the left-eye image IL and the image block B2, corresponding to the image block B1, of the right-eye image IR according to the image blocks B1 and B2, the previous block disparity matrix PBDM and the global disparity matrix GDM. In this embodiment, the image blocks B1 and B2 are the pixel areas located at the same row in the left-eye image IL and the right-eye image IR, respectively, and the previous block disparity matrix PBDM is a disparity matrix corresponding to the pixels of a row before the image blocks B1 and B2, and is not limited herein. The formula used by the local disparity calculating module 108 for calculating energy of a pixel x corresponding to a plurality of disparity candidates in the local energy matrix LEM can be expressed by:

$$E ( x , d ) = {min}_{k} [ E ( x - 1 , k ) + C ( x , k ) + TC ( x , k ) + SC ( x , k ) ] \qquad ( 2 )$$

wherein, E is the accumulative energy, C(x,k)=|Iₗ(x)−Iᵣ(x+k)|, TC(x,k)=f₂(|k−dtₙ₋₁(x)|), SC(x,k)=f₃(|k−ds(x)|), k is a disparity candidate within a certain searching range, Iₗ is a pixel value corresponding to the pixel x in the left-eye image ILL, Iᵣ is a pixel value corresponding to the pixel x in the right-eye image IRL, dt(x) is the disparity corresponding to the pixel x in the global disparity matrix GDM, ds(x) is a disparity corresponding to the same column of the pixel x in the previous block disparity matrix PBDM, and f₂( ) and f₃( ) are non-linear mapping equations similar to f₁( ).

According to equation (2), the local disparity calculating module 108 can acquire the local energy matrix between the image blocks B1 and B2 and calculate the local disparity matrix LDM via the stereo matching algorithm SM2. Please note that the stereo matching algorithm SM2 may be a dynamic programming algorithm. When the difference between the disparity candidate k and the disparity dt(x) corresponding to the same pixel x in the global disparity matrix GDM becomes greater, the value of TC(x,k) becomes larger (i.e. the value of TC(x,k) is proportional to the difference between the disparity candidate k and the disparity dt(x)). Since TC(x,k) is added to the equation (2) and the global disparity matrix GDM has the continuity in time, the local disparity matrix LDM is relative to the disparity information of the previous frame PF. In other words, the local disparity matrix LDM is also relative to the disparity information of the previous frame PF after adding TC(x,k) and therefore equips the continuity in time.

When a difference between the disparity candidate k and the disparity ds(x) located at the same column of the pixel x in previous disparity matrix PBDM is greater, the value of SC(x,k) becomes larger (i.e. the value of SC(x,k) is proportional to the difference between the disparity candidate k and the disparity ds(x)). Via adding SC(x,k) to the equation (2), the local disparity matrix LDM becomes relative to the disparity information of the row before the image blocks B1 and B2. That is, the local disparity matrix LDM equips the continuity in space after adding SC(x,k).

In addition, via observing the left-eye image IL and the right-eye image IR, the time correlation between the disparities of the left-eye image IL and the right-eye image IR and the disparity information of the previous frame PF is lower than the space correlation between the disparities of the left-eye image IL and the right-eye image IR and the disparity information of surrounding pixels. The gain of f₂( ) is set to be greater than that of f₃( ) in equation (2), for ensuring that the accuracy of the disparity information and the stability in time can be acquired, simultaneously, when calculating the local disparity matrix LDM.

After acquiring the local disparity matrix LDM, the stereo matching system 10 stores the global disparity matrix GDM and the local disparity matrix LDM as the previous disparity matrix PDM and the previous block disparity matrix PBDM, respectively, to calculate the disparities of pixels in a row next to the image blocks B1 and B2 in the left-eye image IL and the right-eye image IR. Via repeating the above steps, the stereo matching system 10 can acquire the disparity map of the current frame CF.

Please note that, after adding coefficients relative to the disparity information of the previous frame and the surrounding pixels of the current frame, the disparity acquired by the stereo matching system of the above embodiments equips the stability in time and space and the disparity map thereby becomes stable and accurate. According to different applications, those with ordinary skill in the art may observe appropriate alternations and modifications. For example, the stereo matching system 10 may use a scan-line optimization algorithm as the stereo matching algorithm SM2, and is not limited herein.

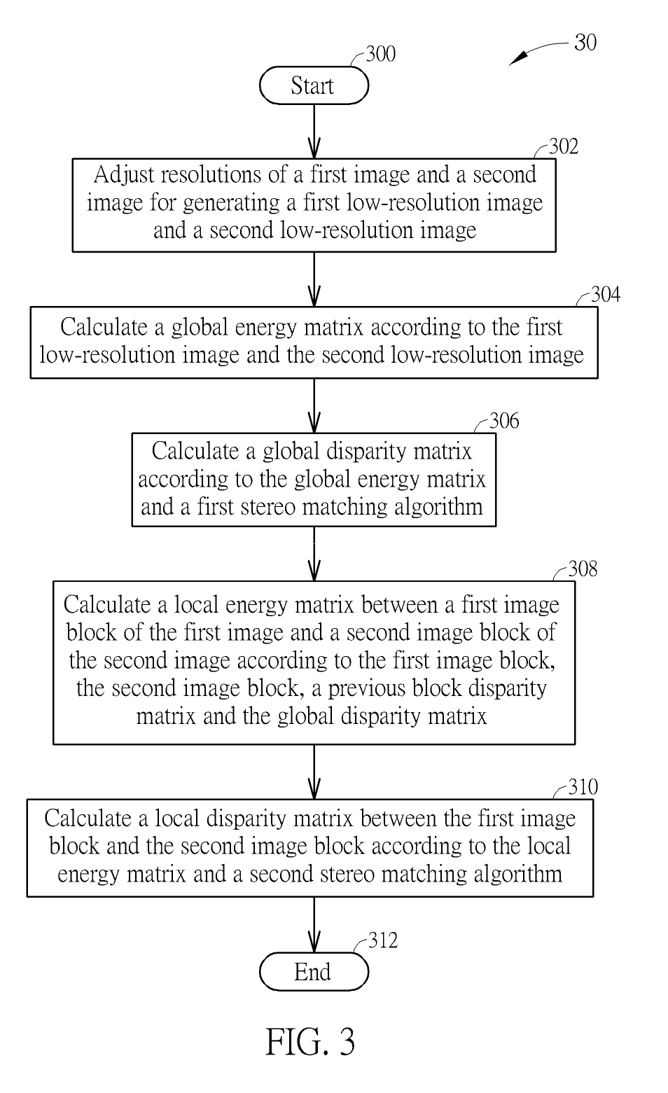

The method of the stereo matching system 10 calculating the local disparity matrix LDM can be summarized into a disparity calculating method 30, as shown in FIG. 3. Please note that, if the same results can be acquired, the sequence of the disparity calculating method 30 is not limited to that shown in FIG. 3. As shown in FIG. 3, the disparity calculating method 30 can be used in a stereo matching system and comprises the following steps:

Step 300: Start.

Step 302: Adjust resolutions of a first image and a second image for generating a first low-resolution image and a second low-resolution image.

Step 304: Calculate a global energy matrix according to the first low-resolution image and the second low-resolution image.

Step 306: Calculate a global disparity matrix according to the global energy matrix and a first stereo matching algorithm.

Step 308: Calculate a local energy matrix between a first image block of the first image and a second image block of the second image according to the first image block, the second image block, a previous block disparity matrix and the global disparity matrix.

Step 310: Calculate a local disparity matrix between the first image block and the second image block according to the local energy matrix and a second stereo matching algorithm.

Step 312: End.

According to the disparity calculating method 30, the stereo matching system can generate an accurate and stable disparity map. Please note that, since the accuracy of the global disparity matrix does not need be to excessive, the disparity calculating method 30 decreases the resolutions of the first image and the second image in step 302 and generates the global energy matrix according to the first low-resolution image and the second low-resolution image acquired in step 302, for reducing the resources of calculating the global energy matrix and the global disparity matrix. The global energy matrix also can be generated according to the first image and the second image. That is, the step 302 can be omitted, and the disparity calculating method 30 generates the global energy matrix according to the first image, the second image and the previous disparity matrix.

To sum up, the disparity calculating method of the above embodiment and the stereo matching system thereof acquires the disparity information with continuity in both time and space via adding coefficients relative to the disparity information of the previous frame and the previous block of the current frame according to a formula of calculating accumulative energy. Accordingly, the disparity calculating method of the above embodiment and the stereo matching system thereof can provide an accurate and stable disparity map.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A disparity calculating method for a stereo matching system, the disparity calculating method comprising:
calculating a global energy matrix according to a first image, a second image and a previous disparity matrix of a previous frame;
calculating a global disparity matrix according to the global energy matrix and a first stereo matching algorithm;
calculating a local energy matrix between a first image block of the first image and a second image block of the second image according to the first image block, the second image block, a previous block disparity matrix and the global disparity matrix; and
calculating a local disparity matrix between the first image block and the second image block according to the local energy matrix and a second stereo matching algorithm.

2. The disparity calculating method of claim 1, wherein the step of calculating the global energy matrix according to the first image, the second image and the previous disparity matrix of the previous frame comprises:
adjusting resolutions of the first image and the second image for generating a first low-resolution image and a second low-resolution image; and
calculating the global energy matrix according to the first low-resolution image and the second low-resolution image.

3. The disparity calculating method of claim 1, wherein a first global energy in the global energy matrix, corresponding to a first position and a first disparity candidate, is proportional to a difference between the first disparity candidate and a first previous disparity corresponding to the first position in the previous disparity matrix.

4. The disparity calculating method of claim 1, wherein a first energy in the local energy matrix, corresponding to a first position and a first disparity candidate, is proportional to a difference between the first disparity candidate and a first global disparity corresponding to the first position in the global disparity matrix.

5. The disparity calculating method of claim 1, wherein a first energy in the local energy matrix, corresponding to a first position and a first disparity candidate, is proportional to a difference between the first disparity candidate and a first previous disparity corresponding to the first position in the previous disparity matrix.

6. The disparity calculating method of claim 1, wherein the second stereo matching algorithm comprises a dynamic programming algorithm.

7. The disparity calculating method of claim 1, wherein the second stereo matching algorithm comprises a scan-line optimization algorithm.

8. A stereo matching system, comprising:
a global disparity storing module, for storing a previous disparity matrix and a global disparity matrix of a previous frame;
a previous block disparity storing module, for storing a previous block disparity matrix between a first image and a second image;
a current block disparity storing module, for storing a local disparity matrix;
a global disparity calculating module, coupled to the global disparity storing module, for calculating a global energy matrix according to the first image, the second image and the previous disparity matrix and calculating the global disparity matrix according to the global energy matrix and a first stereo matching algorithm; and
a local disparity calculating module, coupled to the global disparity storing module, the previous block disparity storing module and the current block disparity storing module, for calculating a local energy matrix between a first image block of the first image and a second image block of the second image according to the first image block, the second image block, the previous local disparity matrix and the global disparity matrix and calculating the local disparity matrix between the first image block and the second image block according to the local energy matrix and a second stereo matching algorithm.

9. The stereo matching system of claim 8, wherein the global disparity calculating module comprises:
a resolution adjusting unit, for adjusting resolutions of the first image and the second image to generate a first low-resolution image and a second low-resolution image; and
a global disparity calculating unit, for calculating the global energy matrix according to the first low-resolution image and the second low-resolution image.

10. The stereo matching system of claim 8, wherein a first global energy in the global energy matrix, corresponding to a first position and a first disparity candidate, is proportional to a difference between the first disparity candidate and a first previous disparity corresponding to the first position in the previous disparity matrix.

11. The stereo matching system of claim 8, wherein a first energy in the local energy matrix, corresponding to a first position and a first disparity candidate, is proportional to a difference between the first disparity candidate and a first global disparity corresponding to the first position in the global disparity matrix.

12. The stereo matching system of claim 8, wherein a first energy in the local energy matrix, corresponding to a first position and a first disparity candidate, is proportional to a difference between the first disparity candidate and a first previous disparity corresponding to the first position in the previous disparity matrix.

13. The stereo matching system of claim 8, wherein the second stereo matching algorithm comprises a dynamic programming algorithm.

14. The stereo matching system of claim 8, wherein the second stereo matching algorithm comprises a scan-line optimization algorithm.
